(19) United States
(12) Patent Application Publication
(10) Pub. No.: US 2022/0050927 A1
(43) Pub. Date: Feb. 17, 2022

(54) Checking a GDFT Operation

(71) Applicant: Infineon Technologies AG, Neubiberg (DE)

(72) Inventor: Rainer Urian, Augsburg (DE)

(21) Appl. No.: 17/395,208

(22) Filed: Aug. 5, 2021

(30) Foreign Application Priority Data
Aug. 12, 2020 (DE) 102020121229.1

(51) Int. Cl. G06F 21/64; G06F 21/60; G06F 17/14; G06F 17/16

(52) U.S. Cl. CPC G06F 21/64; G06F 17/16; G06F 17/141; G06F 21/602

(57) ABSTRACT

A method is described for checking a Generalized Discrete Fourier Transform (GDFT) operation on a secured domain, the method comprising (i) calculating a first checksum based on an input, (ii) determining a result of an GDFT-based operation based on the input, (iii) calculating a second checksum based on the result, (iv) comparing the first checksum and the second checksum and (v) proceeding if the first checksum correspond to the second checksum and otherwise triggering a predefined action if the first checksum does not correspond to the second checksum. Also, an according security device is provided.

### TECHNICAL FIELD

The present disclosure is generally related to cryptographic systems, and is more particularly related to techniques for hindering attacks against cryptographic systems that use the Generalized Discrete Fourier Transform (GDFT).

### BACKGROUND

Ideal lattice-based post quantum cryptography uses the Generalized Discrete Fourier Transform (GDFT) to speed up polynomial multiplication. The GDFT may in particular operate on security critical data (e.g., private keys). A cryptographic operation may be subject to a fault attack, which is a major security threat, especially for smart card security chips.

### SUMMARY

An objective of the present disclosure is to improve existing solutions and in particular to hinder or avoid successful attacks against a cryptographic system or entity. In various embodiments according to the techniques described herein, this is solved according to the features of the independent claims. Further embodiments result from the depending claims.

The examples suggested herein may in particular be based on at least one of the following solutions. Combinations of the following features may be utilized to reach a desired result. The features of the method could be combined with any feature(s) of the device, apparatus or system or vice versa.

A method is provided for checking an GDFT-based operation on a secured domain, the method comprising:
calculating a first checksum based on an input,
determining a result of an GDFT-based operation based on the input,
calculating a second checksum based on the result,
comparing the first checksum and the second checksum and
proceeding if the first checksum corresponds to the second checksum or
triggering a predefined action if the first checksum does not correspond to the second checksum.

The GDFT-based operation may be any operation which uses the GDFT operation or the inverse GDFT operation.

According to an embodiment,
the input is an input vector with N components,
the first checksum and/or the second checksum is determined as a summation over the N elements, wherein each element comprises a multiplication of
   a component of the input vector with
   the same or another component of the input vector with
   a constant.

The constant may be 1 thereby triggering no additional multiplication or the constant may be any other element of the ring [symbol] .

According to an embodiment, the first checksum is determined as:

Σᵢ₌₀^{N-1}xᵢ·xⱼ₍ᵢ₎·cᵢ,

wherein
xᵢ is an element of the input vector,
xⱼ₍ᵢ₎ is xᵢ or a different element of the input vector,
j(i) is a bijective map {0, . . . , N-1}→{0, . . . , N-1},
cᵢ is the constant,
i with i=1, . . . , N-1 is a variable for the summation.

According to an embodiment, the bijective map is defined as:

j(i)=ai mod N,

wherein a is an odd integer.

According to an embodiment, the constant cᵢ is defined as cᵢ=c, with c being a constant in the ring [symbol] .

According to an embodiment, the result is a vector and wherein the second checksum is determined as:

Σᵢ₌₀^{N-1}\hat{x}ᵢ·\hat{x}_{j′(i)}·ĉᵢ,

wherein
\hat{x}ᵢ is an element of the result vector,
\hat{x}_{j′(i)} is \hat{x}ᵢ or a different element of the result vector,
j′(i) is a bijective map {0, . . . , N-1}→{0, . . . , N-1},
ĉᵢ is another constant.

It is noted that the constants cᵢ and ĉᵢ as well as the variable i are elements in the ring [symbol] which are independent from any of the vectors x or \hat{x}.

According to an embodiment, the bijective map is defined as

j′(i)=a′i mod N

with

a′:=a⁻¹ mod N.

According to an embodiment, the constant ĉᵢ is defined as ĉᵢ=ĉ, with ĉ being a constant in the ring [symbol] .

According to an embodiment, the secured domain comprises at least one of the following:
a security device,
a secured cloud,
a secured service,
an integrated circuit,
a hardware security module,
a trusted platform module,
a crypto unit,
a FPGA,
a processing unit,
a controller,
a smartcard.

Also, a security device is provided that is arranged to execute the steps:
calculating a first checksum based on an input,
determining a result of an GDFT-based operation based on the input,
calculating a second checksum based on the result,
comparing the first checksum and the second checksum and
proceeding if the first checksum corresponds to the second checksum or
triggering a predefined action if the first checksum does not correspond to the second checksum.

According to an embodiment, the security device is one of the following or comprises at least one of the following:
a secured cloud,
a secured service,
an integrated circuit,
a hardware security module,
a trusted platform module,
a crypto unit,
a FPGA,
a processing unit,
a controller,
a smartcard.

Furthermore, a computer program product is described, which is directly loadable into a memory of a digital processing device, comprising software code portions for performing the steps of the method as described herein.

Embodiments are shown and illustrated with reference to the drawings. The drawings serve to illustrate the basic principles, so that only aspects necessary for understanding the basic principles are illustrated. The drawings are not to scale. In the drawings the same reference characters denote like features.

### BRIEF DESCRIPTION OF THE FIGURES

FIG. 1 shows an exemplary flow diagram comprising steps for a checksum protected calculation of the GDFT.

FIG. 2 shows an exemplary flow diagram comprising steps for a checksum protected calculation of the inverse GDFT.

FIG. 3 shows steps of an exemplary method of conducting a checksum-protected negatively wrapped GDFT operation that can be used to detect, e.g., fault attacks.

FIG. 4 shows steps of an exemplary method of conducting a checksum-protected operation \hat{x}:=τ⁻¹(GDFT⁻¹(x)), which can be used to detect, e.g., fault attacks.

FIG. 5 shows an exemplary arrangement of a processing device comprising a CPU, a RAM, a non-volatile memory, a crypto module, an analog module, an input/output interface and a hardware-random number generator.

FIG. 6 shows an alternative arrangement with a hardware security module (HSM).

### DETAILED DESCRIPTION

There is a general motivation to move away from classical asymmetric cryptosystems, e.g., Rivest-Shamir-Adleman (RSA) cryptosystems or Elliptic Curve Cryptography (ECC), to schemes that cannot easily be successfully attacked by quantum computers. Even if quantum computers are not currently available, due to the technical complexity and engineering challenges, they might ultimately be able to break RSA and ECC in polynomial time.

One class of schemes that is supposed to resist attacks by quantum computers is directed to Ring Learning with Errors (short RLWE) based public key encryption, key exchange, or signature schemes. The cryptographic building block is called “Ring Learning with Errors” (RLWE). RLWE based cryptography is based on arithmetic of polynomials over finite fields. One prominent cryptographic system based on RLWE is known as NewHope. A basic introduction to NewHope is given by [R. Urian: Understanding Newhope Simple, Prior Art Journal 2020 #8, Infineon Technologies, Prior Art Publishing, Jan. 4, 2020].

However, not much is known regarding the protection of RLWE-based schemes against attacks. Especially, countermeasures against fault attacks (also referred to as fault-injection attacks) may be at least beneficial, if not required, when signature or public key encryption schemes are executed on a secure chip card controller or in any adverse environment.

Examples described herein may in particular refer to a family of checksum equations for the Generalized Discrete Fourier Transform (GDFT), i.e., the discrete Fourier transform over arbitrary rings. This may be understood as a generalization of Parseval's theorem for the discrete Fourier transform over real numbers. The GDFT over finite fields is referred to herein as Number Theoretic Transform (NTT).

Exemplary embodiments may in particular suggest performing a checksum calculation of input and output values of an GDFT. In case the GDFT has not been disturbed, both checksums may correspond to each other, wherein such correspondence may be determined via mathematical formulas. If, however, the GDFT has been disturbed (based on, e.g., an attack against the cryptographic system or entity), the checksums may no longer correspond to each other.

The GDFT is often used in lattice-based cryptography to speed up multiplication in specific polynomial rings. As the GDFT is a security critical operation, the GDFT is beneficially protected against fault attacks.

During a fault attack, the attacker has physical access to the device that is calculating the GDFT, i.e., conducting the GDFT operation. The attacker introduces a fault by disturbing the GDFT operation of the device, e.g., by utilizing a laser and/or by manipulating the voltage or current source.

A fault attack may be prevented by providing protection measures to the device and/or by detecting the physical attack itself. Optionally, an alarm and/or a notification may be triggered when the attack is detected. The GDFT operation may be stopped, the device may enter a safe state and/or it may output a failure message.

Hereinafter, it will be shown how a checksum can be defined to detect fault attacks during the GDFT operation.

### Terminology

The following terms are used throughout this document:
A subscript (e.g., j in xⱼ) for a vector x indicates an index that is used to order and/or distinguish the elements of the vector x. For example, xⱼ is the j-th element of the vector x.
Arithmetic operations on indexes are performed in [symbol] _{N} with a system of representatives {0, 1, . . . , N-1} from the integers. For example, an instance xⱼₐ means that k:=j*a mod N is calculated and then the k-th element xₖ from the vector x is selected. By convention, a negative index −k for k>0 shall mean the index N−k.
The term [symbol] *_{N} refers to the multiplicative subgroup of [symbol] _{N}. Those elements are represented as odd integers.
A capital X indicates an indeterminate in a polynomial.

### The GDFT

[symbol] is defined as a ring with unit 1 and N is an integer. For any integer n, the homomorphic image n·1 in the ring [symbol] may also be referred to as n. Further, ω is a principal N-th root of unity in the ring [symbol] , which has the properties:

ω^{N}=1

Σⱼ₌₀^{N-1}ω^{jk}=0, for 1≤k<N.

The GDFT is a mapping [symbol] ^{N}→ [symbol] ^{N} defined by:

\hat{x}ⱼ:=Σₖ₌₀^{N-1}xₖω^{jk}, with j=0,. . . N-1,

where all xₖ are in [symbol] .

If N is invertible in the ring [symbol] , an inverse mapping GDFT⁻¹: [symbol] ^{N}→ [symbol] ^{N} exists as follows:

\hat{x}ₖ:=N⁻¹Σⱼ₌₀^{N-1}xⱼω^{-jk}, with k=0, . . . , N-1.

If the ring [symbol] is the finite field [symbol] _{q} with q:=p^{d} being a prime power and ω being a primitive N-th root of unity in [symbol] , then this GDFT is referred to as NTT.

### Checksum Equations in GDFT

For any a∈ [symbol] *_{N} and x:=(xₖ)ₖ₌₀^{N-1}∈ [symbol] ^{N}, a mapping is defined as

ψₐ: [symbol] ^{N}→

[symbol]

ψₐ(x):=Σₖ₌₀^{N-1}xₖxₐₖ.

and referred to as checksum functions.

For a=±1 the following checksum functions can be determined:

ψ₁(x)=Σₖ₌₀^{N-1}xₖ²

ψ₋₁(x):=Σₖ₌₀^{N-1}xₖx₋ₖ.

If:

a,a′∈ [symbol] *_{N},

x,\hat{x}∈ [symbol] ^{N},

\hat{x}:=GDFT(x)

a′:=−a⁻¹ mod N,

the checksum functions ψₐ and ψ_{a′} fulfill the following relations:

ψ_{a′}(\hat{x})=Nψₐ(x).

The above-mentioned formula results from the following conversion:

$$\begin{matrix}{ψ}_{{a}^{′}} ( \hat{x} ) = {\sum }_{j = 0}^{N - 1} \hat{{x}_{J}} {x}_{{a}^{′} j} \\ = {\sum }_{j = 0}^{N - 1} ( {\sum }_{k = 0}^{N - 1} {x}_{k} {ω}^{j k} ) ( {\sum }_{{k}^{′} = 0}^{N - 1} {x}_{{k}^{′}} {ω}^{{a}^{′} {jk}^{′}} ) \\ = {\sum }_{k = 0}^{N - 1} {\sum }_{{k}^{′} = 0}^{N - 1} {x}_{k} {x}_{{k}^{′}} {\sum }_{j = 0}^{N - 1} {ω}^{j k} {ω}^{{a}^{′} {jk}^{′}} \\ = {\sum }_{k = 0}^{N - 1} {\sum }_{{k}^{′} = 0}^{N - 1} {x}_{k} {x}_{{ak}^{′}} {\sum }_{j = 0}^{N - 1} {ω}^{j ( k - {k}^{′} )} \\ = {\sum }_{k = 0}^{N - 1} {x}_{k} {x}_{a k} \\ = N {ψ}_{a} ( x ) .\end{matrix}$$

If \hat{x}:=GDFT⁻¹(x) applies, the checksum functions ψₐ and ψ_{a′} fulfill the following relations:

ψ_{a′}(x)=Nψₐ(\hat{x})

### Cryptographic Application

Ideal lattice-based cryptography may use the ring

[symbol]

[X]/(X^{N}−1).

An element in this ring can be represented by a vector

x:=(xⱼ)ⱼ₌₀^{N-1}∈ [symbol] ^{N}.

A multiplication of two elements in the ring [symbol] [X]/(X^{N}−1) corresponds to a convolution operation of the vector representations of those elements, which is a rather expensive operation requiring a significant amount of processing power and time. In order to increase the efficiency of such multiplication in this ring, an isomorphism given by the GDFT may be used. The GDFT maps the convolution operation isomorphically to a component-wise multiplication in [symbol] ^{N} .

Hence, two elements u,v∈ [symbol] ^{N}, which represent elements of the ring [symbol] [X]/(X^{N}−1), can be multiplied by transforming them with the GDFT, performing a component-wise multiplication of the transformed vectors, and transforming the resulting vector back using an inverse isomorphism GDFT⁻:

u*v=GDFT⁻¹(GDFT(u)·GDFT(v)),

wherein “*” indicates convolution in [symbol] ^{N} (i.e., multiplication in the ring [symbol] [X]/(X^{N}−1) and “·” indicates component-wise multiplication in the vector [symbol] ^{N}.

The GDFT (or the inverse GDFT⁻¹) operation may be applied to secret crypto-graphic keys. Faults induced by an attacker during such GDFT operation may lead to a corruption of the cryptographic operation and/or the secret key. Hence, to prevent any further negative impact of an attack, the GDFT or the inverse GDFT⁻¹ operation are favorably able to detect the attack.

Checksum functions can be used to detect fault attacks during the calculation of the GDFT or its inverse GDFT⁻¹.

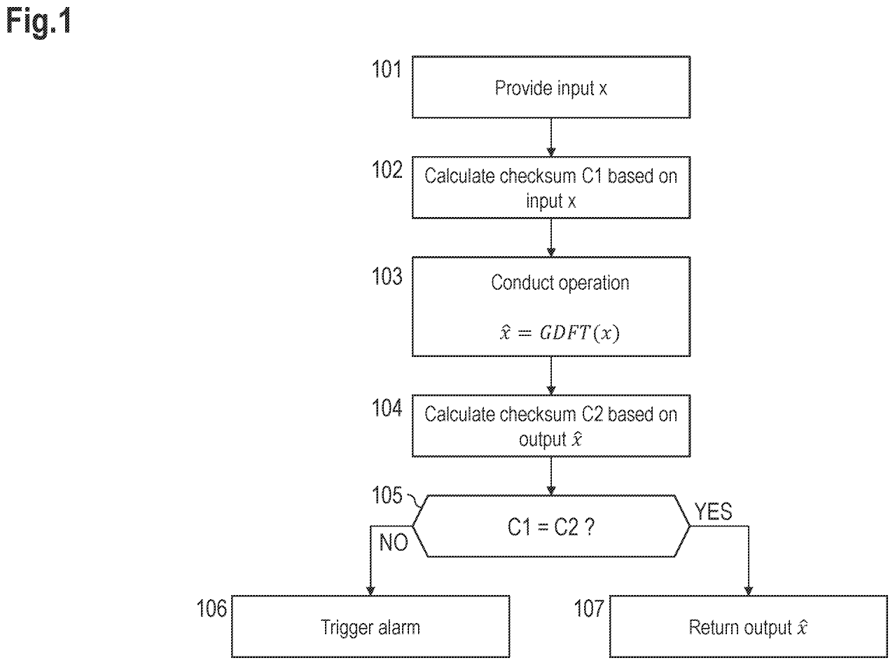

FIG. 1 shows steps of an exemplary method of conducting a checksum-protected GDFT operation that can be used to detect, e.g., fault attacks. In a step 101, an input x∈ [symbol] ^{N} is provided. In a subsequent step 102, a checksum C1 is calculated based on the input x. In a subsequent step 103, the GDFT operation \hat{x}=GDFT(x) is performed on the input x producing an output \hat{x}. Next, in a step 104, a checksum C2 is calculated based on the output \hat{x}. In a subsequent step 105, it is determined whether the checksum C1 equals the checksum C2. If this is the case, it is continued with a step 107 returning the output \hat{x} as a result. If both checksums C1, C2 are not the same, it is branched off to a step 106 triggering an alarm, which indicates that the GDFT operation might have been tampered with.

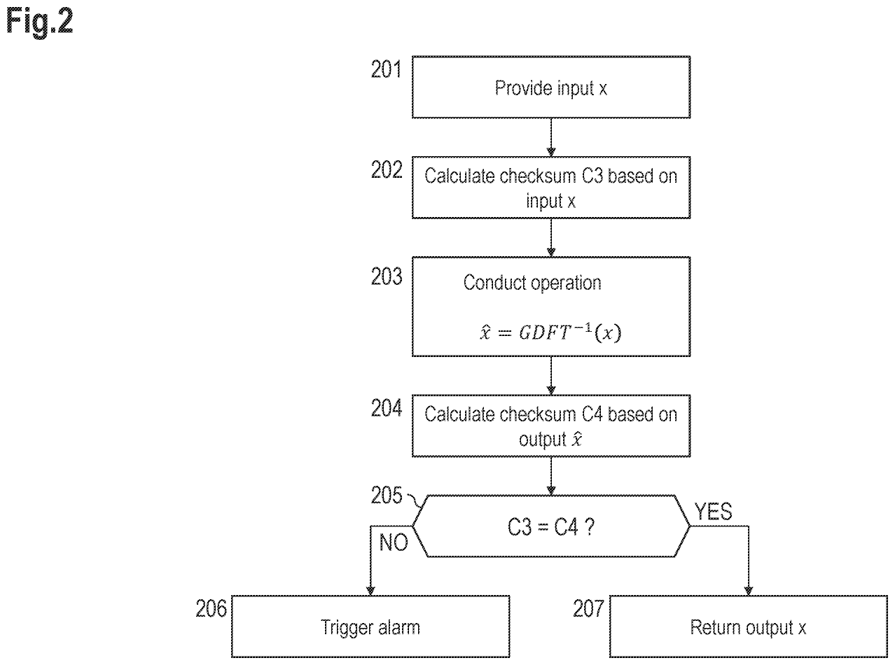

FIG. 2 shows steps of an exemplary method of conducting a checksum-protected GDFT⁻¹ operation that can be used to detect, e.g., fault attacks. In a step 201, the input x∈ [symbol] ^{N} is provided. In a subsequent step 202, a checksum C3 is calculated based on the input x. In a subsequent step 203, the GDFT⁻¹ operation \hat{x}=GDFT⁻¹(x) is performed on the input x producing the output \hat{x}. Next, in a step 204, a checksum C4 is calculated based on the output \hat{x}. In a subsequent step 205, it is determined whether the checksum C3 equals the checksum C4. If this is the case, it is continued with a step 207 returning the output \hat{x}as a result. If both checksums C3, C4 are not the same, it is branched off to a step 206, triggering an alarm, which indicates that the GDFT⁻¹ operation might have been tampered with.

Based on an exemplary implementation of the checksum functions ψₐ and ψ₋ₐ_{^{−1}}, the following checksums C1 to C4 can be calculated:

C1:=Nψₐ(x)

C2:=ψ₋ₐ_{^{−1}}(\hat{x})

C3:=ψ₋ₐ_{^{−1}}(x)

C4:=Nψₐ(\hat{x})

### Negatively Wrapped GDFT

Ideal lattice-based cryptography may also use the polynomial ring [symbol] [X]/(X^{N}+1). An element in this ring can be represented by a vector x:=(xⱼ)ⱼ₌₀^{N-1}∈ [symbol] ^{N}. A multiplication of two elements in the [symbol] [X]/(X^{N}−1) corresponds to a negatively wrapped convolution of their vector representations. The negatively wrapped convolution is similar to the standard convolution and therefore also costly and time consuming.

To increase the efficiency of this multiplication, the GDFT may also be used. However, instead of applying the GDFT directly to the vector, the vector is first transformed by a bijective mapping:

τ(xₖ):=ζ^{k}xₖ,

wherein ζ is a primitive 2N-th root of unity in [symbol] . An inverse mapping can be determined as

τ⁻¹(xₖ):=ζ^{-k}xₖ.

Applying the mapping τ to the GDFT results in the following:

\hat{x}:=GDFT(τ(x)))

\hat{x}ⱼ:=Σₖ₌₀^{N-1}xₖζ^{k}ω^{jk}, j=0, . . . , N-1,

Hence, two elements u,v∈ [symbol] [X]/(X^{N}+1) can be multiplied by first transforming their vector representations using the mapping τ, applying the GDFT, performing a component-wise multiplication of the transformed vectors, transforming the resulting vector back by applying GDFT⁻¹ and then applying the inverse mapping τ⁻¹:

u*v=τ⁻¹(GDFT⁻¹(GDFT(τ(u))·GDFT(τ(v))),

wherein “*” indicates the multiplication (i.e., negatively wrapped convolution) in the ring [symbol] [X]/(X^{N}+1) and “·” indicates the component-wise multiplication in the vector [symbol] ^{N}.

The composition GDFT(τ(x)) may be referred to as negatively-wrapped GDFT. If the checksum functions ψ₁ or ψ₋₁ are composed with τ, then the following formulas apply:

ψ₁(τ(x))=Σₖ₌₀^{N-1}xₖ²ω^{k},

ψ₋₁(τ(x))=x₀²−Σₖ₌₁^{N-1}xₖx_{N-k}.

Checksum functions can be used to detect fault attacks during the calculation of \hat{x}=GDFT(τ(x)) or its inverse \hat{x}=τ⁻¹(GDFT⁻¹(x)).

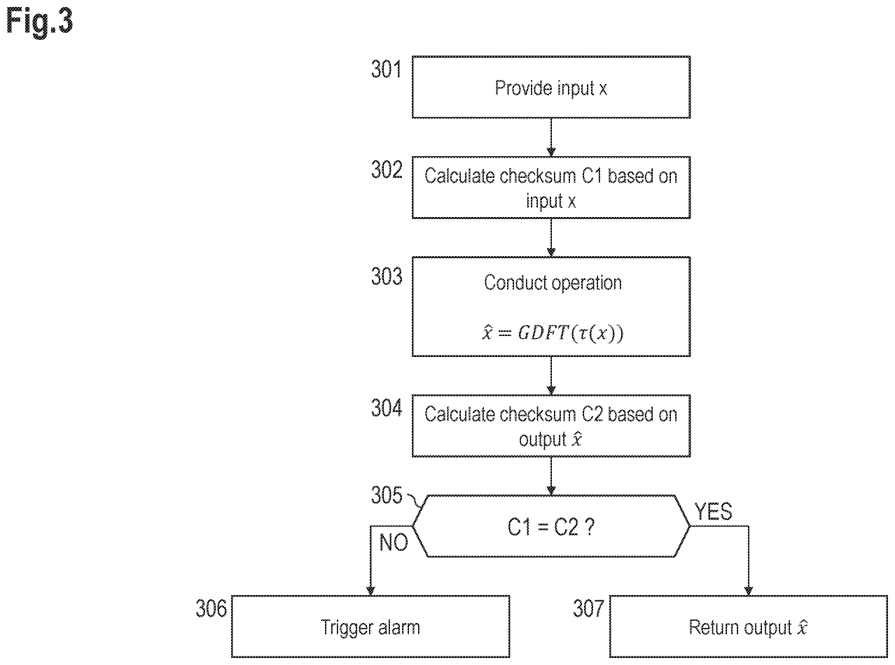

FIG. 3 shows steps of an exemplary method of conducting a checksum-protected negatively wrapped GDFT operation that can be used to detect, e.g., fault attacks. In a step 301, an input x∈ [symbol] ^{N} is provided. In a subsequent step 302, a checksum C1 is calculated based on the input x. In a subsequent step 303, the operation \hat{x}:=GDFT(τ(x)) is performed on the input x using the mapping τ(x) and producing an output \hat{x}. Next, in a step 304, checksum C2 is calculated based on the output \hat{x}. In a subsequent step 305, it is determined whether the checksum C1 equals the checksum C2. If this is the case, it is continued with a step 307 returning the output \hat{x} as a result. If both checksums C1, C2 are not the same, it is branched off to a step 306, triggering an alarm, which indicates that the GDFT operation might have been tampered with.

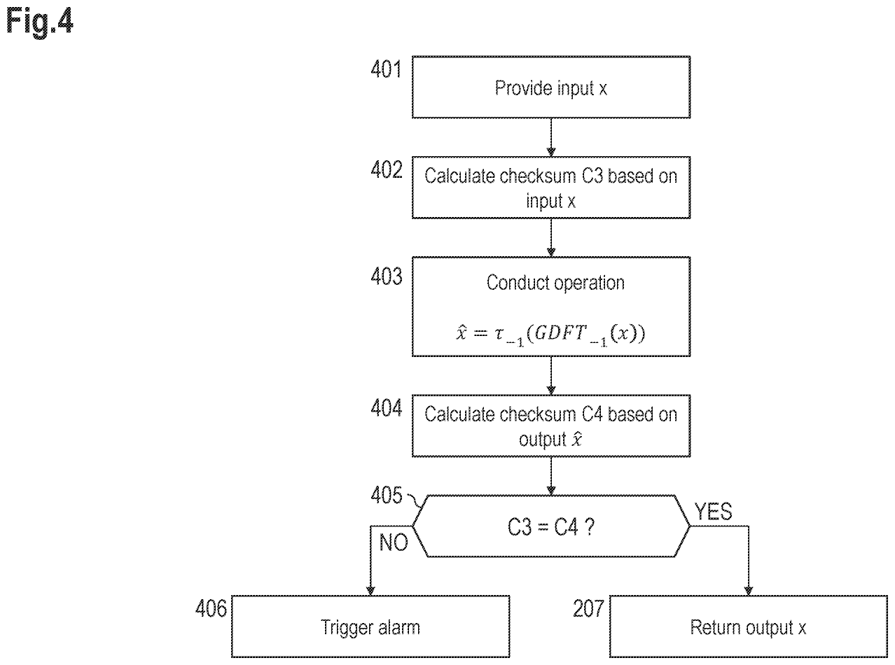

FIG. 4 shows steps of an exemplary method of conducting a checksum-protected GDFT⁻¹ operation that can be used to detect, e.g., fault attacks. In a step 401, the input x∈ [symbol] ^{N} is provided. In a subsequent step 402, a checksum C3 is calculated based on the input x. In a subsequent step 403, the GDFT⁻¹ operation \hat{x}:=τ⁻¹(GDFT⁻¹(x)) is performed on x using the inverse mapping τ⁻¹, producing the output \hat{x}. Next, in a step 404, a checksum C4 is calculated based on the output \hat{x}. In a subsequent step 405, it is determined whether the checksum C3 equals the checksum C4. If this is the case, it is continued with a step 407 returning the output \hat{x} as a result. If both checksums C3, C4 are not the same, it is branched off to a step 406 triggering an alarm which indicates that the τ⁻¹(GDFT⁻¹(x)) operation might have been tampered with.

Based on an exemplary implementation of the checksum functions ψₐ and ψ₋ₐ_{^{−1}}, the following checksums C1 to C4 can be calculated:

C1:=Nψₐ(τ(x))

C2:=ψ₋ₐ_{^{−1}}(\hat{x})

C3:=ψ₋ₐ_{^{−1}}(x)

C4:=Nψₐ(τ(x)). (1)

### Further Aspects and Embodiments

The examples refer to pair of checksum functions ψₐ and ψ₋ₐ_{^{−1}} with corresponding checksums C1 to C4. It is, however, also an option to choose a multitude of different pairs of checksum functions (ψₐ₁,ψ₋ₐ₁_{^{−1}}), (ψₐ₂,ψ₋ₐ₂_{^{−1}}), . . . , for different values aₖ∈ [symbol] *_{N} and calculate the corresponding checksums accordingly. The check may then be conducted over the calculated pairs of checksums.

Using multiple pairs of checksum functions ψₐₖ increases the probability that an attack or fault can be detected.

As another option, the GDFT, the mapping τ, and the checksum calculations can be extended to vectors of elements of the vector [symbol] ^{N} with calculations being conducted in a component-wise manner.

The mapping τ has exemplary been specified as τ(xₖ):=ζ^{k}xₖ, which is in particular practicable for the ring [symbol] [X]/(X^{N}+1). However, other rings may utilize different mappings. Hence, the mapping τ may be any arbitrary bijective mapping from [symbol] ^{N} to [symbol] ^{N}. The checksum formulas can be calculated as shown in equations (1).

### Exemplary Implementations

An exemplary code implementation in Python (Version 3.8.5) is shown hereinafter:
import random
q:int=12289
N:int=1024
omega:int=49
zeta:int=7
N_inv:int=12277

The variable q is the prime with defines the ring [symbol] as a finite field [symbol] _{q}, the variable N is the dimension of the vector over the ring [symbol] , the variable omega corresponds to ω as an exemplary 1024-th root of unity in [symbol] _{q}, the variable zeta corresponds to ζ and is a 2048-th root of unity in [symbol] _{q}, and the variable N_inv corresponds to N-1 mod q.

The operation GDFT is defined as:
def GDFT(x):
   y=[0]*N
   for j in range (0, N):
      for k in range (0, N):
         y[j]=(y[j]+pow(omega, j*k, q)*x[k]) % q
   return y

The inverse operation GDFT⁻¹ is defined as:
def GDFT_inv(x):
   y=[0]*N
   for j in range (0, N):
      for k in range (0, N):
         y[j]=(y[j]+pow(omega, −j*k, q)*[k]) % q y[j]=y[j]*N_inv % q
   return y

The mapping τ(x) is defined as:
def tau(x):
   y=[0]*N
   for k in range(0, N):
      y[k]=(pow(zeta, k, q)*x[k]) % q
   return y

The inverse mapping τ⁻¹(x) is defined as:
def tau_inv(x):
   y=[0]*N
   for k in range (0, N):
      y[k]=(pow(zeta, −k, q)*x[k]) % q
   return y

The checksum functions ψₐ(x) are defined as:
def psi(x, a):
   sum=0
   for k in range (0, N):
      sum=(sum+x[k]*x[(a*k) % N]) % q
   return sum

The function ψ₁(τ(x)) is defined as:
def psi_1_tau(x):
   sum=0
   for k in range (0, N):
      sum=(sum+x[k]*x[k]*pow(omega, k , q)) % q
   return sum

The function ψ₋₁(τ(x)) is defined as:
def psi_minus_1_tau(x):
   sum=(x[0]*x[0]) % q
   for k in range(1, N):
      sum=(sum−x[k]*x[N−k]) % q
   return sum

A random input vector in [symbol] _{q}^{N} can be determined by:
x_inp=list(map(lambda_:random.randint(0, q−1), [0]*N))

The checksums C1 and C2 are calculated for the operation GDFT with a=1:
C1=N*psi(x_inp,1) % q
x_res=GDFT(x_inp)
C2=psi(x_res, −1)
print(“GDFT with a=1:”, “C1=”, C1, “; C2=”, C2)

The checksums C3 and C4 are calculated for the inverse operation GDFT⁻¹ with a=1:
C3=psi(x_inp,−1)
x_res=GDFT_inv(x_inp)
C4=N*psi(x_res, 1) % q
print(“inverse GDFT with a=1:”, “C3=”, C3, “; C4=”, C4)

The checksums C1 and C2 are calculated for the operation GDFT with a=−1:
C1=N*psi(x_inp,−1) % q
x_res=GDFT(x_inp)
C2=psi(x_res, 1)
print(“GDFT with a=−1:”, “C1=”, C1, “; C2=”, C2)

The checksums C3 and C4 are calculated for the inverse operation GDFT⁻¹ with a=−1:
C3=psi(x_inp,1)
x_res=GDFT_inv(x_inp)
C4=N*psi(x_res, −1) % q
print(“inverse GDFT with a=−1:”, “C3=”, C3, “; C4=”, C4)

The checksums C1 and C2 are calculated for negatively wrapped operation GDFT with a=1:
C1=N*psi_1_tau(x_inp) % q
x_res=GDFT(tau(x_inp))
C2=psi(x_res, −1)
print(“negatively wrapped GDFT with a=1:”, “C1=”, C1, “; C2=”, C2)

The checksums C3 and C4 are calculated for negatively wrapped inverse operation GDFT⁻¹ with a=1:
C3=psi(x_inp,1)
x_res=tau_inv(GDFT_inv(x_inp))
C4=N*psi_minus_1_tau(x_res) % q
print(“neg. wrapped inv. GDFT with a=1:”, “C3=”, C3, “; C4=”, C4)

The checksums C1 and C2 are calculated for negatively wrapped operation GDFT with a=−1:

C1=N*psi_minus_1_tau(x_inp) % q
x_res=GDFT(tau(x_inp))
C2=psi(x_res, 1)
print (“neg. wrapped GDFT with a=−1:”, “C1=”, C1, “; C2=”, C2)

The checksums C3 and C4 are calculated for negatively wrapped inverse operation GDFT⁻¹ with a=−1:
C3=psi(x_inp, −1)
x_res=tau_inv(GDFT_inv(x_inp))
C4=N*psi_1_tau(x_res) % q
print(“neg. wrapped inv. GDFT with a=−1:”, “C3=”, C3, “; C4=”, C4)

Executing the Python program reveals a pair of checksums (C1, C2) for the GDFTs and a pair of checksums (C3, C4) for the negatively wrapped GDFTs, showing that the respective checksums of each pair (C1, C2) and (C3, C4) have the same values. An exemplary print based on random numbers is:
GDFT with a=1: C1=8795; C2=8795
inverse GDFT with a=1: C3=3015; C4=3015
GDFT with a=−1: C1=2821; C2=2821
inverse GDFT with a=−1: C3=5061; C4=5061
negatively wrapped GDFT with a=1: C1=4594; C2=4594
neg. wrapped inv. GDFT with a=1: C3=5061; C4=5061
neg. wrapped GDFT with a=−1: C1=2007; C2=2007
neg. wrapped inv. GDFT with a=−1: C3=3015; C4=3015

The checks are positive as the checksum pairs C1 and C2 as well as the checksum pairs C3 and C4 are the same.

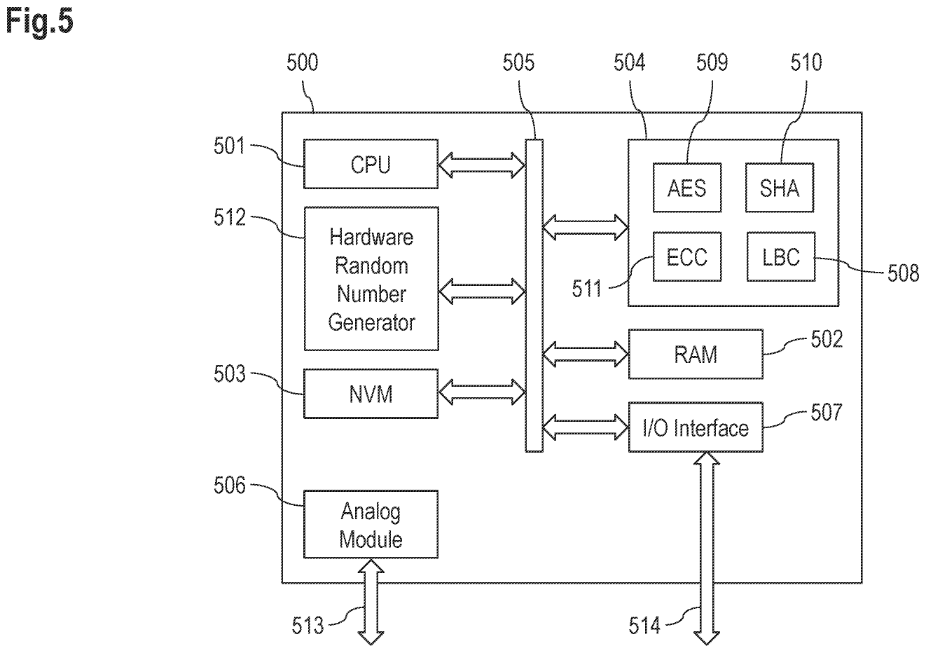

FIG. 5 shows a processing device 500 comprising a CPU 501, a RAM 502, a non-volatile memory 503 (NVM), a crypto module 504, an analog module 506, an input/output interface 507 and a hardware-random number generator 112.

In this example, the CPU 501 has access to at least one crypto module 504 over a shared bus 505 to which each crypto module 504 is coupled. Each crypto module 504 may in particular comprise one or more crypto cores to perform certain cryptographic operations. Exemplary crypto cores are:
an AES core 509,
a SHA core 510,
an ECC core 511, and
a RLWE crypto core 508.

In particular, the RLWE-based crypto core 508 may be provided in order to accelerate at least one of the following: the GDFT operation, the τ isomorphism, the checksum calculation or any of its inverse.

The CPU 501, the hardware random number generator 112, the NVM 503, the crypto module 504, the RAM 502 and the input/output interface 507 are con-nected to the bus 505. The input output interface 507 may have a connection to other devices, which may be similar to the processing device 500.

The crypto module 504 may or may not be equipped with hardware-based security features.

The bus 505 itself may be masked or plain. Instructions to process the steps de-scribed herein may in particular be stored in the NVM 503 and processed by the CPU 505. The data processed may be stored in the NVM 503 or in the RAM 502. Supporting functions may be provided by the crypto modules 504 (e.g., expansion of pseudo random data).

Steps of the method described herein may exclusively or at least partially be con-ducted on the crypto module 504, e.g., on the RLWE-based crypto core 508.

The processing device 500 may be a chip card powered by direct electrical contact or through an electro-magnetic field. The processing device 500 may be a fixed circuit or based on reconfigurable hardware (e.g., Field Programmable Gate Array, FPGA). The processing device 500 may be coupled to a personal computer, microcontroller, FPGA or a smart phone.

The solution described herein may be used by a customer that intends to provide a secure implementation of RLWE-based cryptography on a smart card or any secure element.

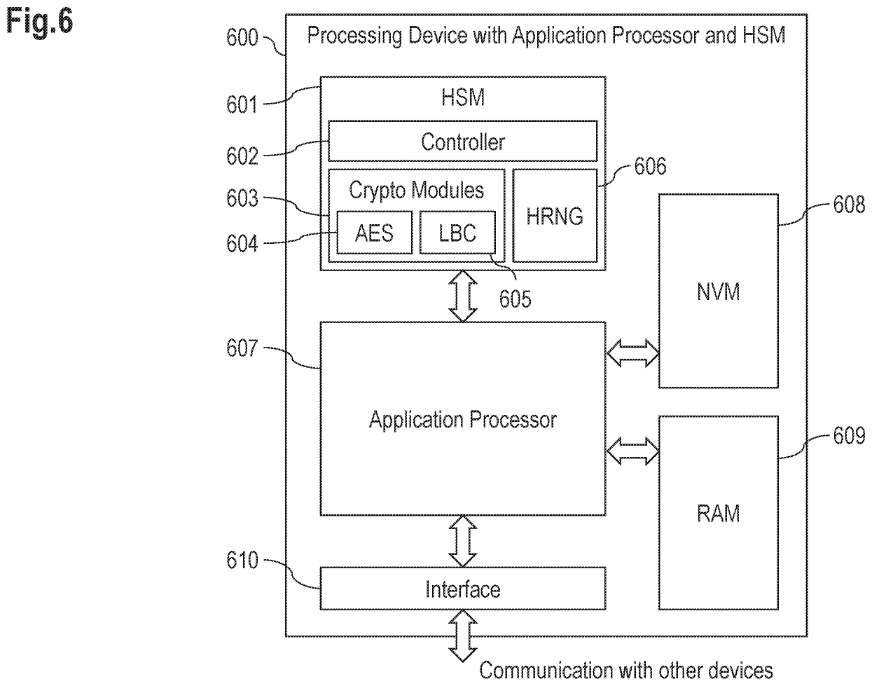

FIG. 6 shows another example of a processing device 600. The processing device 600 comprises a hardware security module 601, a non-volatile memory (NVM) 608, a random-access memory (RAM) 609, an interface 610 for communication with other devices and an application processor 607, which is coupled with the hardware security module (HSM) 601, the RAM 609, the NVM 608 and the inter-face 610.

The HSM 601 comprises a controller 602, a hardware-random number generator (HRNG) 606 and at least one crypto module 603. The crypto module 603 exemplarily comprises an AES core 604 and a lattice-based crypto (LBC) core 605.

According to one embodiment, the HSM 601 and the application processor 607 may be fabricated on the same physical chip with a tight coupling. The HSM 601 delivers cryptographic services and secured key storage while the application processor may perform computationally intensive tasks (e.g., image recognition, communication, motor control). The HSM 601 may be only accessible by a defined interface and considered independent of the rest of the system in a way that a security compromise of the application processor 607 has only limited impact on the security of the HSM 601. The HSM 601 may perform all tasks or a subset of tasks described with respect to the processing device 600 by using the controller 602, the LBC 605, supported by, exemplary, an AES 604 and the HRNG 606. It may execute the procedures described herein (at least partially) either controlled by an internal controller or as CMOS circuit. Moreover, also the application processor 607 may perform the procedures described herein (at least partially, e.g., in collaboration with the HSM 601).

The processing device 600 with this application processor 607 and HSM 601 may be used as a central communication gateway or (electric) motor control unit in cars or other vehicles.

In one or more examples, the functions described herein may be implemented at least partially in hardware, such as specific hardware components or a processor. More generally, the techniques may be implemented in hardware, processors, soft-ware, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium, i.e., a computer-readable transmission medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Instructions may be executed by one or more processors, such as one or more central processing units (CPU), digital signal processors (DSPs), general purpose microprocessors, application specific integrated circuits (ASICs), field programmable logic arrays (FPGAs), or other equivalent integrated or discrete logic circuitry. Accordingly, the term “processor”, as used herein may refer to any of the foregoing structure or any other structure suitable for implementation of the techniques de-scribed herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a single hardware unit or provided by a collection of interoperative hardware units, including one or more processors as described above, in conjunction with suitable software and/or firmware.

Embodiments of the techniques, apparatuses, and systems described above include, but are not limited to the following enumerated examples:

A. A method for checking a Generalized Discrete Fourier Transform (GDFT)-based operation on a secured domain, the method comprising:
calculating a first checksum based on an input;
determining a result of the GDFT-based operation based on the input;
calculating a second checksum based on the result;
comparing the first checksum and the second checksum; and
proceeding if the first checksum corresponds to the second checksum and otherwise triggering a predefined action if the first checksum does not correspond to the second checksum.

B. The method of example A: wherein the input is an input vector with N components; and wherein the first checksum and/or the second checksum is determined as a summation over the N elements, wherein each element comprises a multiplication of a component of the input vector with the same or another component of the input vector with a constant.

C. The method of example B, wherein the first checksum is determined as:

Σᵢ₌₀^{N-1}xᵢ·xⱼ₍ᵢ₎·cᵢ, wherein
xᵢ is an element of the input vector,
xⱼ₍ᵢ₎ is xᵢ or a different element of the input vector,
j(i) is a bijective map {0, . . . , N-1}→{0, . . . , N-1},
cᵢ is the constant, and
i with i=1, . . . , N-1 is a variable for the summation.

D. The method of example C, wherein j(i):=ai mod N, wherein a is an odd integer.

E. The method of example C or D, wherein cᵢ:=c, with c being a constant in the ring [symbol] .

F. The method of any of examples B-E, wherein the result is a vector and wherein the second checksum is determined as

Σᵢ₌₀^{N-1}\hat{x}ᵢ·\hat{x}_{j′(i)}·ĉᵢ, wherein
\hat{x}ᵢ is an element of the result vector,
\hat{x}ⱼ₍ᵢ₎ is \hat{x}ᵢ or a different element of the result vector,
j′(i) is a bijective map {0, . . . , N-1}→{0, . . . , N-1},
ĉᵢ is another constant.

G. The method of example F, wherein j′(i):=a′i mod N, with a′:=−a⁻¹ mod N.

H. The method of example F or G, wherein ĉᵢ:=ĉ, with ĉ being a constant in the ring [symbol] .

I. The method of any of examples A-H, wherein the secured domain comprises at least one of any one or more of the following: a security device, a secured cloud, a secured service, an integrated circuit, a hardware security module, a trusted platform module, a crypto unit, a FPGA, a processing unit, a controller, and a smartcard.

J. A security device comprising processing circuitry and memory configured to:
calculate a first checksum based on an input;
determine a result of a Generalized Discrete Fourier Transform (GDFT)-based operation based on the input;
calculate a second checksum based on the result;
compare the first checksum and the second checksum; and
proceed if the first checksum corresponds to the second checksum and otherwise trigger a predefined action if the first checksum does not correspond to the second checksum.

K. The device of example J, wherein the security device is one of the following or comprises at least one of the following: a secured cloud, a secured service, an integrated circuit, a hardware security module, a trusted platform module, a crypto unit, a FPGA, a processing unit, a controller, and a smartcard.

L. A non-transitory computer-readable medium comprising, stored thereupon, a computer program for execution by a digital processing device, the computer program comprising instructions configured to cause the digital processing device to:
calculate a first checksum based on an input;
determine a result of a Generalized Discrete Fourier Transform (GDFT)-based operation based on the input;
calculate a second checksum based on the result;
compare the first checksum and the second checksum; and
proceed if the first checksum corresponds to the second checksum and otherwise trigger a predefined action if the first checksum does not correspond to the second checksum.

Although various exemplary embodiments of the invention have been disclosed, it will be apparent to those skilled in the art that various changes and modifications can be made which will achieve some of the advantages of the invention without departing from the spirit and scope of the invention. It will be obvious to those reasonably skilled in the art that other components performing the same functions may be suitably substituted. It should be mentioned that features explained with reference to a specific figure may be combined with features of other figures, even in those cases in which this has not explicitly been mentioned. Further, the methods of the invention may be achieved in either all software implementations, using the appropriate processor instructions, or in hybrid implementations that utilize a combination of hardware logic and software logic to achieve the same results. Such modifications to the inventive concept are intended to be covered by the appended claims.

What is claimed is:

1. A method for checking a Generalized Discrete Fourier Transform (GDFT)-based operation on a secured domain, the method comprising:
calculating a first checksum based on an input;
determining a result of the GDFT-based operation based on the input;
calculating a second checksum based on the result;
comparing the first checksum and the second checksum; and
proceeding if the first checksum corresponds to the second checksum and otherwise triggering a predefined action if the first checksum does not correspond to the second checksum.

2. The method of claim 1:
wherein the input is an input vector with N components; and
wherein the first checksum and/or the second checksum is determined as a summation over the N elements, wherein each element comprises a multiplication of a component of the input vector with the same or another component of the input vector with a constant.

3. The method of claim 2, wherein the first checksum is determined as:
Σᵢ₌₀^{N-1}xᵢ·xⱼ₍ᵢ₎·cᵢ,
wherein
xᵢ is an element of the input vector,
xⱼ₍ᵢ₎ is xᵢ or a different element of the input vector,
j(i) is a bijective map {0, . . . , N-1}→{0, . . . , N-1},
cᵢ is the constant, and
i with i=1, . . . , N-1 is a variable for the summation.

4. The method of claim 3, wherein
j(i):=ai mod N,
wherein a is an odd integer.

5. The method of claim 3, wherein
cᵢ:=c,
with c being a constant in the ring [symbol] .

6. The method of claim 2, wherein the result is a vector and wherein the second checksum is determined as
Σᵢ₌₀^{N-1}\hat{x}ᵢ·\hat{x}_{j′(i)}·ĉᵢ,
wherein
\hat{x}ᵢ is an element of the result vector,
\hat{x}ⱼ₍ᵢ₎ is \hat{x}ᵢ or a different element of the result vector,
j′(i) is a bijective map {0, . . . , N-1}→{0, . . . , N-1},
ĉᵢ is another constant.

7. The method of claim 6, wherein
ĉᵢ:=ĉ,
with ĉ being a constant in the ring [symbol] .

8. The method of claim 6, wherein
j′(i):=a′i mod N
with
a′:=−a⁻¹ mod N.

9. The method of claim 8, wherein
ĉᵢ:=ĉ,
with ĉ being a constant in the ring [symbol] .

10. The method of claim 1, wherein the secured domain comprises at least one of any one or more of the following:
a security device,
a secured cloud,
a secured service,
an integrated circuit,
a hardware security module,
a trusted platform module,
a crypto unit,
a FPGA,
a processing unit,
a controller, and
a smartcard.

11. A security device comprising processing circuitry and memory configured to:
calculate a first checksum based on an input;
determine a result of a Generalized Discrete Fourier Transform (GDFT)-based operation based on the input;
calculate a second checksum based on the result;
compare the first checksum and the second checksum; and
proceed if the first checksum corresponds to the second checksum and otherwise trigger a predefined action if the first checksum does not correspond to the second checksum.

12. The device of claim 11, wherein the security device is one of the following or comprises at least one of the following:
a secured cloud,
a secured service,
an integrated circuit,
a hardware security module,
a trusted platform module,
a crypto unit,
a field-programmable gate array (FPGA),
a processing unit,
a controller, and
a smartcard.

13. A non-transitory computer-readable medium comprising, stored thereupon, a computer program for execution by a digital processing device, the computer program comprising instructions configured to cause the digital processing device to:
calculate a first checksum based on an input;
determine a result of a Generalized Discrete Fourier Transform (GDFT)-based operation based on the input;
calculate a second checksum based on the result;
compare the first checksum and the second checksum; and
proceed if the first checksum corresponds to the second checksum and otherwise trigger a predefined action if the first checksum does not correspond to the second checksum.
